(19) United States
(12) Patent Application Publication
(10) Pub. No.: US 2025/0271853 A1
(43) Pub. Date: Aug. 28, 2025

(54) REMOTE WEB BASED CONTROLS FOR AUTONOMOUS OPERATIONS

(71) Applicant: Outrider Technologies, Inc., Brighton, CO (US)

(72) Inventors: Gabriel Netty, Anaheim, CA (US); Daniel McCoy, Eastvale, CA (US); Kathleen Ann Mahoney, Naples, FL (US); Truong Vo, Glendora, CA (US); Brook Thomas, Reno, NV (US); Justin Abel, Denver, CO (US); Ira Alexander Renfrew, Lexington, MA (US)

(21) Appl. No.: 19/063,870

(22) Filed: Feb. 26, 2025

Related U.S. Application Data
(60) Provisional application No. 63/558,476, filed on Feb. 27, 2024.

(51) Int. Cl. G05D 1/225; B65G 63/00; G05D 1/646; G05D 101/00; G05D 105/28; G05D 107/80; G06Q 10/087; G07C 5/00

(52) U.S. Cl. CPC G05D 1/225; B65G 63/00; G05D 1/646; G07C 5/008; B65G 2203/0216; G05D 2101/22; G05D 2105/28; G05D 2107/80; G06Q 10/087

(57) ABSTRACT

A mission control may receive, from a yard management system (YMS), a move request identifying a destination spot in a yard and one or more of a trailer identifier of a trailer to be moved, a pick-up spot of the trailer, and a trailer type. Mission control determines whether the move request is feasible for an autonomous vehicle (AV). When the move request is feasible, mission control generates a mission defining directives to control the AV to move the trailer from the pick-up spot to the destination spot and sets, via an application programming interface (API) of the YMS, a status of the move request to indicate autonomous move is scheduled.

### RELATED APPLICATION

This application claims priority to U.S. Patent Application No. 63/558,476, titled “Remote Web Based Controls for Autonomous Operations,” filed Feb. 27, 2024, and which is incorporated herein by reference in its entirety.

### BACKGROUND

A yard management system (YMS) controls a customer's inventory of trailers within a yard (e.g., a warehouse with loading docks and a staging area) and schedules movement of the trailers between parking spots and loading docks for loading and unloading of trailer content. The YMS maintains a queue of trailer move requests, some being handled by manually driven vehicles, and others being sent to a mission control for handling by autonomous vehicles. When an autonomous vehicle is unable to autonomously complete the move request, mission control notifies the YMS that the move cannot be completed autonomously, which causes the YMS to reschedule the move for manual handling. Disadvantageously, this causes disruption to the scheduled manual movements, resulting in inefficiency within the yard. Further, status of the autonomous vehicles is not visible within the YMS, and thus the user of the YMS is unable to see a true status of all moves within the yard. This requires the user to simultaneously monitor information from mission control to be aware of all trailer movement activity within the yard, which is inconvenient and inefficient.

These problems also apply to other application areas where autonomous vehicles work alongside yard trucks, such as in ports, intermodal rail terminals, and any other location where trailers are moved autonomously such as where semi-trailers are used for highway freight movement and shipping containers are moved on wheeled-chassis. The problem also applies to use of Terminal Operating Systems (TOS), Warehouse Management Systems (WMS), and Transportation Management Systems (TMS) that are used for tracking movement of the trailers and containers.

### SUMMARY

One aspect of the present embodiments includes the realization that it is difficult to monitor both (a) a yard management system (YMS) that defines asset movements and tracks manually driven vehicles, and (b) a mission control that provides management of autonomous vehicles within the yard, to track all vehicle and inventory movements. The present embodiments solve this problem by interfacing mission control directly with the YMS (via APIs) and allowing mission control to update the status of the autonomous trailer movements directly within the YMS. Advantageously, this allows a user of the YMS to see the status of all trailer moves (manual and autonomous) within the yard.

Another aspect of the present embodiments includes the realization that it is inefficient for the user of the YMS to send certain ones of the trailer move requests to mission control for autonomous handling without monitoring the status of mission control. The present embodiments solve this problem by allowing mission control to automatically select ones of the move requests stored on the YMS that could be handled by autonomous vehicles, and updating the status of the selected moves within the YMS. Advantageously, mission control selects move requests based on certain criteria that allow for efficient operation of the autonomous vehicles, leaving others to be handled manually. Further, mission control monitors (grooms) the yard during normal operation and automatically updates the status of parking spots and loading docks in an inventory of the YMS, thereby making the information displayed to the user of the YMS more current and thereby increasing yard efficiencies. For example, AVs operating within the yard collect information of parking spots that are nearby and/or passed. Using the collected information, mission control determines when a trailer is positioned in a parking spot, which parking spots are empty, and automatically updates the status of the relevant parking spot in the YMS, thereby correcting the YMS inventory for trailers that are parked incorrectly.

Another aspect of the present embodiments includes the realization that mission control may determine that a destination spot for a move is not empty. The present embodiments solve this problem by having mission control find a nearby empty spot within the YMS inventory and generate an updated mission plan to direct an AV to park the trailer in the nearby empty spot instead of the destination spot.

Another aspect of the present embodiments includes the realization that an AV may determine that a destination spot for a move is not empty. The AV uses imagery and deep learning algorithms to determine when a destination spot is empty, for example. The present embodiments solve this problem by having the AV request an alternative empty nearby spot from mission control. Mission control generates a updated mission plan to use the alternative empty nearby spot when found in the YMS inventory, and sends the updated mission plan to the AV, causing the AV to park the trailer in the alternative empty nearby spot. When mission control cannot find an empty nearby spot, mission control directs the AV to search nearby for an empty spot. For example, mission control may direct the AV to traverse the apron looking for empty spots. When the AV finds an empty spot, the AV identifies the empty spot to mission control and receives an updated mission plan to deposit the trailer in the empty spot.

Another aspect of the present embodiments includes the realization that when a move is received to move a specific trailer to a destination spot, mission control searches a yard inventory for the specific trailer to identify a pick-up spot, and generates a mission plan to cause an AV to move the specific trailer from the pick-up spot to the destination spot. When the AV identifies the specific trailer in a different spot while moving towards the requested pick up spot, the AV communicates the different pick-up spot to mission control and awaits an updated mission to mode the specific trailer from the different spot to the destination spot. When, as the AV moves towards the pick-up spot, mission control receives updated inventory information defining a new spot for the specific trailer from another AV at the yard, mission control generates an updated mission for the AV that redirects the AV to the new spot. When the AV arrives at the pick-up spot, the AV uses imagery and deep learning algorithms to determine whether the requested trailer is at the pick-up spot. When the requested trailer is not at the pick-up spot, the AV requests a new pick-up spot for the requested trailer from mission control. When mission control determines a new pick-up spot for the specific trailer from the YMS inventory, mission control generates an updated mission plan to cause the AV to collect the specific trailer from the new pick up spot. Mission control send the updated mission plan to the AV, which causes the AV to proceed to the new pick up spot. When mission control does not determine a new pick-up spot for the requested trailer, mission control instructs the AV to search nearby for the specific trailer. For example, mission control may direct the AV to traverse the apron looking for nearby trailers that match the specific trailer. When the specific trailer is found by the AV, the AV identifies a new pick up spot to mission control and receives an updated mission plan to move the specific trailer from the new pick-up spot to the destination spot.

Another aspect of the present embodiments includes the realization that a move request may only identify a trailer type to be moved to a destination spot. For example, a move request may state “move an empty 28′ dry van to a destination spot.” Advantageously, the YMS stores a status and location of trailers within a trailer database and the inventory. Accordingly, mission control searches for the trailer type in the yard inventory, and when a trailer matches the trailer type, mission control assigns the matching trailer to the move request and generates a mission to cause the AV to move the matching trailer from a pick-up spot (e.g., the current location of the matching trailer) to the destination location. The AV uses imagery and deep learning algorithms to identify the trailer at the pick-up spot, allowing mission control to verify it is of the correct type. When the identified trailer does not match the trailer type, the AV requests a new match for the trailer type from mission control. When mission control finds another trailer matching the requested trailer type in the inventory, mission control updates the mission plan with a new trailer identifier and a new pick-up spot. The updated mission is sent to the AV and causes the AV to proceed to the new pick up spot. When mission control does not have a trailer of requested trailer type in inventory, mission control instructs the AV to search nearby for at least one parked trailer and to detect its trailer identifier. For example, mission control may direct the AV to traverse the apron looking for a nearby trailer of the requested trailer type. If a trailer is found by the AV, the AV sends its identity and a new pick-up spot of the found trailer to mission control, which determines whether the identified trailer matches the trailer type. When a match is found, mission control generates a new mission to move the found trailer from the new pick-up spot to the destination.

Another aspect of the present embodiments includes the realization that certain move requests cannot be performed by an autonomous vehicle and returning these moves for manual handling disrupts the scheduling of drivers. The present embodiments solve this problem by determining, as early as possible and preferably prior to attempting the move by an autonomous vehicle, ones of the move requests listed in the YMS that cannot be handled autonomously. Advantageously, move requests flagged early as being non-autonomous cause less disruption to the drive schedule.

Another aspect of the present embodiments includes the realization that an autonomous vehicle occasionally needs manual assistance and that to allow an operator to assist an AV remotely requires a current, stable, and continuous display of conditions at the autonomous vehicle on an operator console. Where the assisting operator is remote from the yard, telemetering all information captured by the autonomous vehicle via the remote support platform to the operator console is not possible due to a limited bandwidth between the autonomous vehicle and the remote operator console without causing undesirable delays in information displayed to the operator. The present embodiments solve this problem by using a video bakery at the autonomous vehicle to intelligently select information sent to the remote support platform based on the reason for the request for remote assistance. Advantageously, the video bakery automatically selected relevant portions of the available image (still and video) feeds from the multiple cameras of the AV, adjusting the resolution and/or frame rate as needed, to form telemetry data with needed information at the best available quality (e.g., best frame rate and resolution) that is within the available bandwidth.

Another aspect of the present embodiments includes the realization that manual software configuration updates of AVs deployed at a customer's yard is impractical, particularly where the updates apply to many AVs at many different locations, and where each AV requires a different configuration. The present embodiments solve this problem by providing a vehicle credential management (VCM) server in the cloud that allows each AV to automatically update itself based on a configuration definition in a configuration database. Advantageously, an operator defines or updates the configuration definition to indicate needed software and/or credentials in the configuration database, where the configuration definition is associated with unique AV identifiers of AVs that should be provisioned. In response to receiving an update request from the AV (e.g., triggered during initialization or booting of the AV controller), the VCM server provides the AV with the updated software configuration, including corresponding credentials, from a secure credential vault.

In certain embodiments, the techniques described herein relate to a remote based control method for autonomous operation, including: receiving, in a mission control from a yard management system (YMS), a move request defining a destination spot in a yard and one or more of a trailer identifier of a trailer to be moved, a pick-up spot of the trailer, and a trailer type; determining, at the mission control, whether the move request is feasible for an autonomous vehicle (AV); and when the move request is feasible: generating a mission defining directives to control the AV to move the trailer from the pick-up spot to the destination spot; and setting, via an application programming interface (API) of the YMS, a status of the move request to indicate autonomous move scheduled.

### BRIEF DESCRIPTION OF THE FIGURES

FIG. 1 is a schematic diagram illustrating example remote web based controls for autonomous operation, in embodiments.

FIG. 2 is a block diagram illustrating operation of the assessor of FIG. 1 in further example detail.

FIG. 3 is a block diagram illustrating mission control of FIG. 1 with a remote support platform that allows a remote operator to use an operator console to remotely monitor and control any one AV, in embodiments.

FIG. 4 is a block diagram illustrating example detail of the AV of FIGS. 1 and 3, in embodiments.

FIG. 5 shows one example VCM system that facilitates autonomous configuration of the AV of FIG. 1, in embodiments.

FIG. 6 is a flowchart illustrating one example VCM method, in embodiments.

FIG. 7 is a flowchart illustrating one example remote based control method for autonomous operation, in embodiments.

FIG. 8 is a flowchart illustrating one example video bakery method for an autonomous vehicle having a plurality of cameras, in embodiments.

### DETAILED DESCRIPTION OF THE EMBODIMENTS

The following embodiments and examples relate to a yard management system (YMS) that controls a customer's inventory of trailers within a yard (e.g., a warehouse with loading docks and a staging area) and schedules movement of the trailers between parking spots and loading docks for loading and unloading of trailer content. However, the embodiments hereof may also be used for intermodal rail and/or port applications and apply to use of a Terminal Operating Systems (TOS), a Warehouse Management System (WMS), and a Transportation Management System (TMS) at any location where trailers are moved autonomously, such as where semi-trailers are used for highway freight movement and where shipping containers are moved on wheeled-chassis as seen as part of port and rail applications, without departing from the scope hereof. For sake of brevity and clarity, the terms YMS and trailers are intended to cover all these options, where the term trailer refers to both semi-trailers used for highway freight movement and to shipping containers that are moved on wheeled chassis that are typically seen as part of port and rail applications.

### Mission Control Updated

Mission control (MC) is a service that manages autonomous vehicles (AVs) in a customer's yard, which may have a staging area for arriving and departing trailers, and a warehouse with loading docks for loading assets to and unloading assets from the trailers. The customer uses a yard management system (YMS) to track and control arrival of trailers and contained assets to the yard, movement of trailers and assets in the yard, and departure of trailers with assets from the yard. Conventionally, to use the AV to move the trailers between parking spots in the staging areas and loading docks at the warehouse, the customer sends certain trailer move requests to MC to be performed by AVs, and schedules other move requests to be performed manually by drivers. MC generates missions for the AVs to perform the received move requests. When the move request is completed successfully, MC indicates to the YMS that the move request was a success (e.g., the move was done or complete). Where the AV is unable to complete the move, MC indicates to the YMS that the move request was rejected (e.g., the move was not done or is incomplete). The rejection occurs for many different reasons, including: a system error, a damaged trailer, criteria falling outside an operating design domain (ODD) of the AVs, inventory issue, issue at the dock such as a dock light not being green, and so on. Move requests that are rejected are rescheduled for manual handling by the YMS, which is often disruptive to already scheduled manual operations when the rejection is delayed, such as when it occurs after unsuccessful attempts to move the trailer by the AV.

To overcome these problems and advance the art, MC is updated to interact directly with the YMS to provide a more streamlined and transparent AV operation. One key advantage is that the updated MC implements a pull model using an application programming interface (API) of the YMS. MC accesses information within the YMS to determine which move requests may be completed by AVs, and marking other move requests as unsuitable to AVs. MC evaluates each move request prior to selecting for AV operation. Where information within MC indicates that the move request has an issue (e.g., a damaged trailer, criteria falling outside ODD, inventory issue, issue at the dock like a light not being green, etc.) that prevent handling by an AV, MC does not pull the move request from the YMS. At any stage after pulling the move request to attempting and completing the move, MC may return a status to the YMS with a rejection as the result of a system error, a later discovered issue with the move (including those listed previously above) or move completed successfully. MC automatically returns a notice to the YMS indicating a status of the move request. Advantageously, MC automatically selects only move requests that may be handled by an AV based on continuously updated knowledge of the yard and trailers, resulting in fewer move requests being rejected and manually scheduled by the YMS, and less disruption to the manual operation.

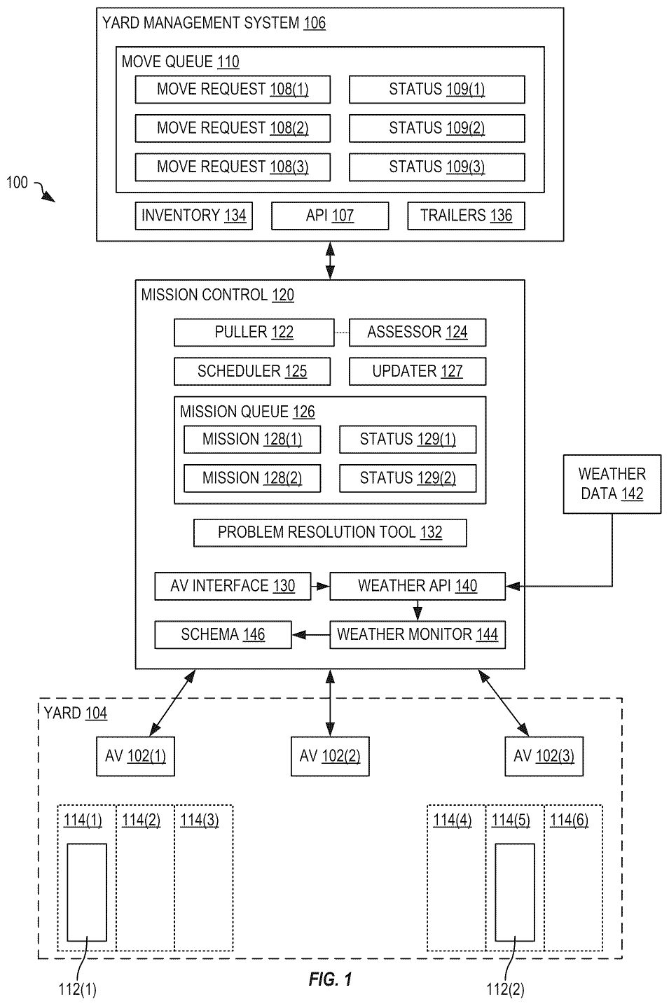

FIG. 1 is a schematic diagram illustrating example remote web based controls 100 for autonomous operation, in embodiments. A customer operates a yard management system 106 (YMS 106) to manage an inventory 134 that tracks locations of trailers 112 within a yard 104. Yard 104 has a plurality of parking spots 114 (e.g., staging area parking spots and loading dock parking spots) that may, or may not, have a trailer parked therein. For example, where yard 104 includes a warehouse, certain parking spots 114 are loading docks of the warehouse, and other parking spots 114 are in a staging area from which newly arrived trailers are collected and to which trailers ready for departure are delivered. YMS 106 maintains inventory 134 of trailers 112 within yard 104, defines which parking spot 114 each trailer is parked in, and generates move requests 108 to schedule movement of trailers 112 within yard 104, as needed for loading and unloading of assets for example. In certain embodiments, inventory 134 also maintains a trailer database 136 that indicates a status of each trailer 112, such as trailer type, trailer health (e.g., damage and/or trailer operability), and trailer contents, such as whether trailer 112 is empty or not. In the example of FIG. 1, trailer 112(1) is parked in parking spot 114(1) and trailer 112(2) is parked in parking spot 114 (5).

An enhanced mission control 120 (MC 120, which may be an onsite computer server and/or cloud based service) controls operation of at least one AV 102 (AV 102) in yard 104 to autonomously move trailer 112 from a starting parking spot 114 to a destination spot 114 based on a move request 108 retrieved from YMS 106. In the example of FIG. 1, MC 120 controls three AVs 102(1), 102(2), and 102(3) within yard 104; however, MC 120 may control more or fewer AVs 102 and may concurrently operate AVs within other yards.

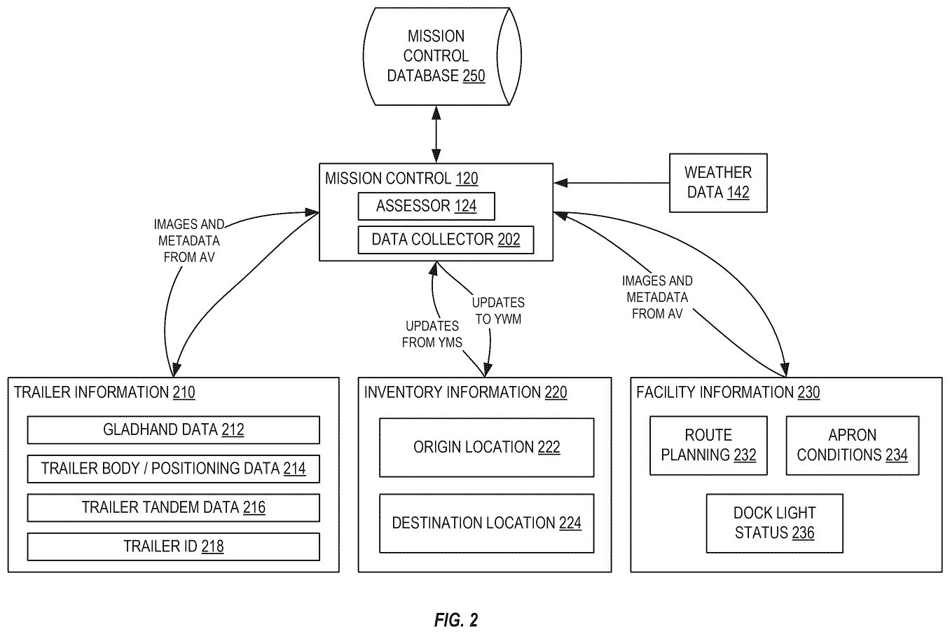

MC 120 includes a puller 122, an assessor 124, a scheduler 125, an updater 127, a problem resolution tool 132, and an AV interface 130, implemented as software that controls at least one processor to implement functionality of MC 120 as described herein. MC 120 also maintains a mission queue 126 for storing missions 128 to be performed by AVs 102. Puller 122 interacts, directly via an API 107, with YMS 106 to autonomously detect a new or updated move request 108 within a move queue 110. Puller 122 invokes assessor 124 to determine whether move request 108 is feasible (e.g., meets certain criteria that indicate that AV 102 is able to perform the move), invokes scheduler 125 to generate a mission 128 stored within mission queue 126, and updates a corresponding status 129 within move queue 110. For example, updater 127 automatically updates, via API 107, status 109 within move queue 110 of YMS 106 to reflect a status of mission 128. Advantageously, YMS 106 displays the status of both manual moves and autonomous moves such that a user of YMS 106 does not need to switch to viewing a dashboard of MC 120 to see a current status of all moves within yard 104. Operation of assessor 124 is described in further detail below with reference to FIG. 2. Problem resolution tool 132 is invoked to resolve moves that cannot be completed, such as when a pick-up spot is empty or a destination spot is already occupied.

In one example of operation, puller 122 detects move request 108(1) within mission queue 126 of YMS 106, where move request 108(1) requests movement of trailer 112(1) from parking spot 114(1) to parking spot 114(4). Puller 122 invokes assessor 124 to determine the move is feasible, whereby assessor 124 determines (a) that trailer 112(1) is parked in parking spot 114(1), (b) that parking spot 114(4) is empty, (c) that AV 102(1) is available and capable of moving trailer 112(1) from parking spot 114(1) to parking spot 114(4), and (e) that the move meets certain criteria (e.g., the trailer in undamaged, criteria does not fall outside ODD, there is no inventory issue, there are no issue at the dock such as the dock light not being green, etc.). For example, AV 102 may be configured to move a forty-eight-foot dry van, but is not configured to move a container trailer. Puller 122 then invokes scheduler 125 to generate mission 128(2) with directives that control AV 102(1) to move trailer 112(1) from parking spot 114(1) to parking spot 114(4), stores mission 128(2) in mission queue 126, sets a corresponding status 129(2) to “in progress”, and invokes updater 127 to update corresponding status 109(1) of YMS 106.

In another example of operation, where move request 108(2) requests movement of trailer 112(1) from parking spot 114(1) to parking spot 114(4), puller 122 detects move request 108(2) within mission queue 126 of YMS 106, and invokes assessor 124 to determine whether the move is feasible for AV 102. In this example, assessor 124 determines that parking spot 114(4) is not empty based on evidence recently captured by a drive-by of parking spot 114(4) by one AV 102, which indicated that another trailer is parked in parking spot 114(4). Accordingly, assessor 124 invokes updater 127 to interact with YMS 106 and set corresponding status 109(2) to indicate that the move is not possible. In certain embodiments, updater 127 may provide additional reasons, such as indicating that the move is not possible because parking spot 114(4) is not empty, and may further indicate the identity of the trailer currently in parking spot 114(4). Assessor 124 may also send a notification to YMS 106 (e.g., to a user of YMS 106) indicating that the trailer move is not possible and that an alternative destination spot is needed. In certain embodiments, assessor 124 invokes problem resolution tool 132 to determine whether another nearby parking spot (e.g., parking spot 114(6)) would be acceptable for parking trailer 112(1), whereby problem resolution tool 132 updates mission 128(2) to indicate parking spot 114(6) as the destination spot for trailer 112(1).

AV 102 collects information of parking spots 114 as it maneuvers within yard 104. In certain embodiments, AV 102 includes functionality to automatically search nearby for parking spots 114 that are empty, and/or to identify trailers in nearby parking spots to allow MC 120 to updates its mission 128 accordingly. For example, where a destination spot is occupied, AV 102 identifies an empty nearby spot, and requests MC 120 to update its mission 128 to deposit trailer 112 in parking spot 114 that was found to be empty. MC 120 may also update inventory 134 of YMS 106 based on a status of parking spots 114 detected by AVs 102 during normal operation within yard 104. For example, as AV 102 maneuvers within yard 104, AV 102 captures information (e.g., using one or more of its cameras, its LIDAR, and its radar, etc.) indicative of the state of yard 104. For example, AV 102 may capture information such as trailer IDs 218 and a status of any trailer detected in parking spots 114 passed by AV 102. The trailer information may indicate whether trailer 112 has damaged would prevent autonomous movement of the trailer, or whether the positioning of trailer 112 within parking spot 114 prevents autonomous movement of the trailer, and so on. AV 102 may also collect other yard information such as unidentified or unexpected objects (e.g., dropped pallets, trash, tools, etc.) that would impede movement of AVs 102 and/or trailers 112 within yard 104, etc. Advantageously, inventory 134 is automatically updated during normal operation of AVs 102 within yard 104 and is therefore kept updated without requiring additional control of the AVs 102.

In one operational example, as AV 102 reaches a destination spot of mission 128, when AV 102 determines that the destination spot is not empty, AV 102 notifies MC 120 to request an empty nearby spot. MC 120 invokes problem resolution tool 132 to identify an acceptable nearby parking spot and update move request 108 with the destination spot. Problem resolution tool 132 then generates a updated mission 128 to deposit trailer 112 in the nearby parking spot, and sends updated mission 128 to AV 102. When problem resolution tool 132 cannot find an empty nearby spot, problem resolution tool 132 instructs AV 102 to search nearby to find an empty spot. For example, AV 102 processes captured imagery using deep learning algorithms to identify an empty nearby spot. When AV 102 finds an empty nearby spot, AV 102 sends the empty nearby spot to problem resolution tool 132, which updates move request 108 and mission 128 to deposit trailer 112 in the empty nearby spot, and sends updated mission 128 to AV 102, causing AV 102 to deposit trailer 112 in the empty nearby spot. Problem resolution tool 132 also notifies YMS 106 that the trailer is parked in the nearby spot and not the intended destination. Problem resolution tool 132 may also update YMS 106 to identify the trailer, based on the captured information from AV 102, within the originally intended destination spot.

When AV 102 determines that a pick-up spot of a current mission 128 (corresponding to move request 108) is empty, indicating the trailer is not found, AV 102 notifies MC 120 that the pick-up spot is empty. Accordingly, MC 120 invokes problem resolution tool 132 to search YMS 106 for an updated location of the trailer identified in the corresponding move request 108, and when found, problem resolution tool 132 updates the pick-up location in the corresponding move request 108, generates a new mission 128 based on the updated pick-up spot, and sends it to AV 102, thereby causing AV 102 to traverse to the updated pick up location to collect the identified trailer. When problem resolution tool 132 does not find a new location for the requested trailer, problem resolution tool 132 instructs AV 102 to search nearby spots for the requested trailer. For example, AV 102 processes captured imagery using deep learning algorithms to identify nearby trailers, and when AV 102 finds the trailer (e.g., based on a trailer identifier) in a nearby spot, AV 102 sends the nearby spot to problem resolution tool 132. Accordingly, problem resolution tool 132 generates a new mission 128 based on the nearby spot, sends the new mission 128 to AV 102, which causes AV 102 to collect the trailer from the nearby spot.

AV interface 130 processes mission queue 126 and sends missions 128 to the assigned AVs 102. For example, AV interface 130 sends mission 128(2) to the AV 102(1) to instruct AV 102(1) to move trailer 112(1) from parking spot 114(1) to parking spot 114(4). If, during mission 128(2), AV 102(1) detects an anomaly preventing the trailer move, AV 102(1) reports the anomaly to AV interface 130, which may attempt to resolve the anomaly (e.g., invoking a remote support platform—remote assist) or may invoke updater 127 to update the corresponding status 129(2) and status 109(3) of YMS 106.

Advantageously, puller 122 and assessor 124 cooperate to select only ones of move requests 108 that may be performed by AVs 102. Where assessor 124 determines that move request 108 cannot be performed autonomously, assessor 124 sets the corresponding status 109 to indicate that autonomous move is not possible. Advantageously, YMS 106 is updated to reflect the status of each move request 108 such that these moves may be handled manually.

A further advantage of using API 107 to interact with YMS 106 directly, is that assessor 124 may improve operational efficiency of AVs 102 by selecting and scheduling ones of move requests 108 that minimize wasted movement of AVs 102. For example, missions 128 may be ordered within mission queue 126 to reduce wait times and minimize movement of each AV 102 between trailer moves. For example, within the defined movement windows of move requests 108, assessor 124 may select and schedule missions 128 based on the locations of starting and ending parking spots 114 to minimize movement of each AV 102 when not moving trailers.

In another example of operation, move request 108 indicates that an identified trailer 112 is to be moved to a destination spot, but does not specify the pick-up spot. Since the pick-up spot is undefined, MC 120 invokes problem resolution tool 132 to search YMS 106 (e.g., a yard inventory stored at YMS 106) for the identified trailer to determine a pick-up spot. When the pickup spot is found, problem resolution tool 132 generates a new mission 128 to cause AV 102 to move the identified trailer from the pick-up spot to the destination spot.

In another example of operation, move request 108 indicates that a trailer type is to be moved to a destination spot, but does not identify the trailer or specify the pick-up spot. For example, move request 108 may state “move an empty 28′ dry van to a destination spot.” Accordingly, MC 120 invokes problem resolution tool 132 to search for the trailer type in trailer database 136 and then to determine the location of matching trailers 112 within inventory 134. When a matching trailer is found, problem resolution tool 132 assigns the found trailer type to move request 108 and generates mission 128 to cause AV 102 to move the matching trailer from its pick-up spot (e.g., the current location of the matching trailer) to the destination location. The AV uses imagery and deep learning algorithms to identify the trailer at the pick-up spot to verify that the matching trailer is parked in the pick-up spot. When the identified trailer does not correspond to the matched trailer, AV 102 sends the trailer identifier to problem resolution tool 132 and requests a new location for another trailer matching the trailer type from problem resolution tool 132. When problem resolution tool 132 finds another trailer matching the requested trailer type in the inventory, problem resolution tool 132 updates mission 128 with a new trailer identifier and a new pick-up spot. Updated mission 128 is sent to AV 102 and causes AV 102 to proceed to the new pick up spot to collect the trailer. When problem resolution tool 132 does not find a match within trailer database 136, problem resolution tool 132 instructs AV 102 to search nearby and identify parked trailers 112. AV 102 sends the identify of found trailers to problem resolution tool 132, which determines whether the found trailer matches the required trailer type of move request 108. When the identified trailer matches the required trailer type, problem resolution tool 132 generates a new mission 128 based on a new pick-up spot (e.g., received from AV 102 with the trailer ID) of the matching trailer, sends the new mission 128 to AV 102 to cause AV 102 to move the matching trailer from the new pick-up spot to the destination spot.

### Weather Notifications

MC 120 also includes a weather API 140, a weather monitor 144 and an operational schema 146. Weather API 140 that allows MC 120 to ingest weather data 142 (e.g., weather forecasts, local weather reports, etc.). Operational schema 146 defines an operational status of MC 120 and may include an operational status of AVs 102, and a predicted operational status of AVs 102. Operational schema 146 is used by other components of MC 120 and defines operation parameters of MC 120 and AVs 102.

Weather monitor 144 processes weather data 142 to determine a current and/or future operational status of AVs 102 and updates operational schema 146 accordingly. Weather data 142 may include one or more of a weather forecast received from a third party weather service for an area including yard 104, a weather report (e.g., current weather conditions) from a local weather station, and a status report defined from one or more sensors of AV 102 and included in telemetry data received via AV interface 130.

Weather monitor 144 processes weather data 142 and updates operational schema 146 of MC 120 to define current and future operability of AVs 102. For example, where weather data 142 indicates heavy snow between 3 PM and 6 PM, weather monitor 144 updates operational schema 146 to indicate that AVs 102 are not operable between 3 PM and 6 PM. Similarly, where weather monitor 144 determines from weather data 142 that heavy rain has started falling, weather monitor 144 updates operational schema 146 to indicate operation of AVs 102 is not possible. In another example, where weather monitor 144 determines from weather data 142 that mist is reducing visibility, weather monitor 144 updates operational schema 146 to indicate operation of AVs 102 is restricted and/or not possible.

Where weather monitor 144 changes operational schema 146, such as when weather data 142 first indicates heavy snow between 3 PM and 6 PM, weather monitor 144 may also send a weather notification to YMS 106 (e.g., users thereof) and/or operators of MC 120. Advantageously, predicted outage of autonomous trailer movement allows the user of YMS 106 to plan alternative arrangements, such as to provide drivers to ride in AVs 102 during reduced visibility, and/or to use manual (non-autonomous) yard tractors for trailer movement during weather conditions in which AVs 102 cannot operate.

### Move Capability

FIG. 2 is a block diagram illustrating operation of assessor 124 of FIG. 1 in further example detail. Assessor 124 may indicate that move request 108 is not feasible for a variety of reasons, and accordingly the move request is rejected. Advantageously, assessor 124 determines that move request 108 is not feasible at the earliest opportunity by evaluating many known facts that could influence the corresponding mission 128. The sooner move request 108 is rejected, the sooner it may be reassigned and completed, resulting in better efficiency within yard 104. Additionally, data known before executing mission 128 may result in faster completion of the move request 108. Accordingly, MC 120 collects data continuously and throughout every area in yard 104 as AVs 102 operate, and MC 120 uses the collected data to inform assessor 124 and the planner of missions 128.

Each AV 102 collects data that is sent to a data collector 202 of MC 120. For example, data collector 202 may be part of a cloud service that aggregates this data and makes it available to other components of remote web based controls 100 to inform behavior. Data collector 202 receives updates from YMS 106 that include trailer information 210, inventory information 220, and facility information 230. Data collector 202 may also receive trailer information 210, inventory information 220, and facility information 230 from AVs 102 operating within yard 104. In certain embodiments, MC 120 stores collected data in an MC database 250 and thereby automatically detects changes indicated by trailer information 210, inventory information 220, and facility information 230. Data collector 202 may communicate detected changes to other components of remote web based controls 100 and to YMS 106. Data collector 202 may also pull information from MC database 250 and/or YMS 106. The following description provides examples of how certain data points are used.

Trailer information 210 relates to information about trailer 112 that is collected by any AV 102 that is near trailer 112. Trailer information 210 may be used by assessor 124 to determine when move request 108 are not feasible for a particular trailer prior to start of a corresponding mission 128. Trailer information 210 may include gladhand data 212, trailer body and positioning data 214, trailer tandem data 216, and a trailer ID 218. Trailer information 210 may also indicate where trailer 112 is damaged. For example, trailer information 210 may indicate one or more of roof damage, sidewall damage, connector damage, and other issues that prevent autonomous handling of trailer 112 and/or indicate that trailer 112 is in need of repair. In certain embodiments, trailer information 210 is sent to update YMS 106 and corresponding requested autonomous operations on trailer 112 that cannot be completed are returned to YMS 106 (e.g., rejected by MC 120). Gladhand data 212 may include type, position, and state of gladhands (e.g., from images captured by AVs 102) of gladhands on any trailer in yard 104. Accordingly, assessor 124 may reject moves of trailer 112 when it has a damaged gladhand without requiring an AV to drive to the trailer, since the damage was reported by another AV 102 when passing trailer 112. Further, gladhand data 212 may help with pose estimation for autonomous connections during execution of the corresponding mission 128. Trailer body and positioning data 214 indicates a status of the trailer body and its position with a parking spot 114 for example. Trailer body and positioning data 214 may be collected by AVs passing the trailer and/or reported by YMS 106. Assessor 124 may use trailer body and positioning data 214 to determine when trailer 112 is damaged or in a position that prevents hitching by AV 102, whereby assessor 124 rejects the move request 108 prior to generating the corresponding mission 128 or requiring an AV to visit the trailer. Trailer tandem data 216 defines the position of tandems on trailer 112 and may be used by motion planning of MC 120 when preparing mission 128 and thus before executing the mission such that time of the in-move calculation is reduced. In certain embodiments, AV 102 processes captured images to determine trailer ID 218. In other embodiments, MC 120 processes images received from AV 102 to determine trailer ID 218.

Inventory information 220 defines inventory parameters that allow assessor 124 to assess move request 108 before generation and/or execution of the corresponding mission 128. For example, assessor 124 rejects move requests 108 or initiates exception planning when inventory information 220 indicates that trailer 112 is not parked in the expected parking spot 114 and/or when the intended destination spot 114 is not empty. Inventory information 220 may include origin location 222 and destination location 224 for identified trailer 112. For example, as AVs 102 drive around yard 104, they may detect and report trailer identities and locations, including trailer body and positioning data 214, whereby data collector 202 updates corresponding inventory information 220 in MC database 250 and/or YMS 106. Origin location 222 allows assessor 124 to confirm that the expected trailer 112 is in the origin location or plan a contingency. Destination location 224 allows assessor 124 to confirm the destination location is unoccupied or plan a contingency.

Facility Information 230 includes information about conditions of yard 104 and may be received from YMS 106 and/or received from AVs 102 as they traverse yard 104 and/or from remote operators when responding to assist requests. Facility information 230 allows assessor 124 to determine when AV 102 is unable to perform the move prior to generation or execution of the corresponding mission 128, resulting in earlier rejection of move request 108, contingency planning, or exception communication. Facility information 230 may include route planning 232, apron conditions 234, and dock light status 236. Route planning 232 allows MC 120 to adjust missions 128 within specified parameters to optimize routes ahead of time. For example, when mission 128 tasks AV 102 to autonomously select an available parking spot, AV 102 may select one that is slightly further away to minimize global execution time of mission 128 and a subsequent mission. MC 120 evaluates (e.g., continually, at intervals, and/or in response to events) one or more of mission queue 126, trailer information 210, inventory information 220, and facility information 230 to reorganize (e.g., optimize efficiency) missions 128 of mission queue 126 based on changes, collected by data collector 202, to the state of yard 104. For example, MC 120 instructs AV 102 to modify its current course (e.g., mid-mission) to improve efficiency of tasks being performed within yard 104. Apron conditions 234 allows MC 120 to plan routes around issues developed in the apron. Dock light status 236 allows assessor 124 to determine when a red or damaged dock light would prevent completion of the corresponding mission 128, communicate and exception, and/or move the mission 128 down mission queue 126 once, such that a subsequence mission 128 may be started. When the prevented mission is attempted again, when the same condition (e.g., red or damaged dock light) remains, the mission is moved down mission queue 126 again and the subsequent mission 128 executed.

### Remote Support Platform (RSP)

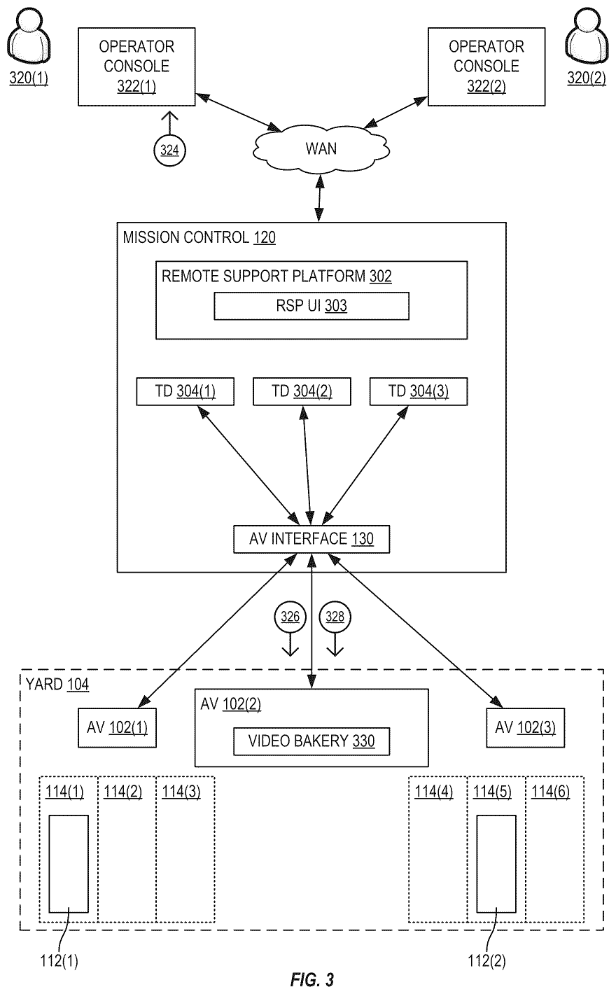

FIG. 3 is a block diagram illustrating MC 120 of FIG. 1 with a remote support platform 302 that allows a remote operator 320 to use an operator console 322 to remotely monitor and control any one AV 102, in embodiments. In certain embodiments, operator console 322 runs a browser that interacts with a RSP user interface 303 of remote support platform 302 and/or a user interface of MC 120. Operator console 322 may communicate with remote support platform 302 to send a telemetry request 326 to AV 102 to monitor operation thereof. Remote support platform 302 may also request operator console 322 assist AV 102, such as when AV 102 requests assistance during autonomous operation, whereby remote support platform 302 sends telemetry request 326 to AV 102 to initiate telemetry feed 324. For example, where AV 102 is unable to couple (hitch) with a trailer, AV 102 may requests assistance after three unsuccessful autonomous attempts, whereby remote operator 320 uses operator console 322 to control RSP user interface 303 to send telemetry request 326 to AV 102, receive telemetry feed 324 (e.g., including at least part of telemetry data 304) from AV 102, and may send one or more control directives 328 to AV 102 via further interaction with RSP user interface 303 via operator console 322. In another example, when AV 102 is unable to resolve a detected object within an image with sufficient confidence, AV 102 requests assistance, whereby remote operator 320 uses operator console 322 to receive telemetry data 304 in telemetry feed 324 from AV 102 and interact with RSP user interface 303 to resolve the object. Further, operator console 322 may display AV status and events, including weather, at a yard as they occur, allowing operator 320 to make operational decisions and assist a customer (e.g., owner of yard 104) as needed. Advantageously, the AVs may be remotely monitored and assisted from anywhere in the world with a stable internet connection via remote support platform 302.

Remote support platform 302 is a full-stack application (e.g., a full end-to-end software development) that allows operators to monitor and assist AVs 102 performing missions 128 and interact with MC 120 to generate missions 128 that command the AVs as needed. A conventional remote monitoring and control tool provides individual control of an AV, but does not scale to allow control of an entire fleet of AVs and does not have the ease-of-use and reach as a web application to provide remote monitoring and control of any AV via a stable internet connection. Particularly, remote support platform 302 allows any remote operator 320 to provide assistance to any AV 102.

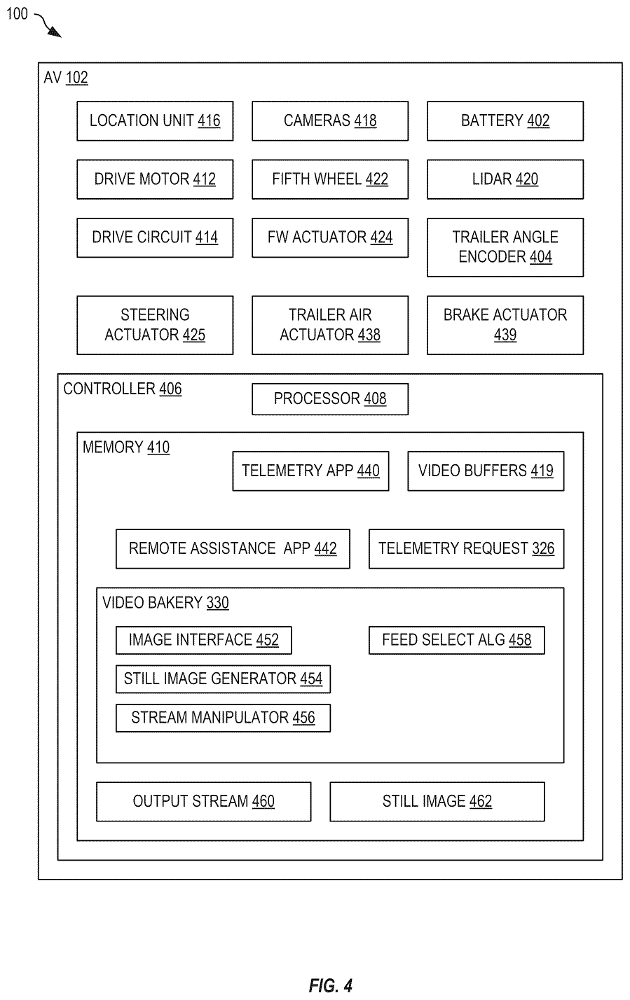

FIG. 4 is a block diagram illustrating example detail of AV 102 of FIGS. 1 and 3, in embodiments. FIGS. 3 and 4 are best viewed together with the following description.

AV 102 includes a battery 402 for powering components of AV 102 and a controller 406 with at least one digital processor 408 communicatively coupled with memory 410 that may include one or both of volatile memory (e.g., RAM, SRAM, etc.) and non-volatile memory (e.g., PROM, FLASH, Magnetic, Optical, etc.). Memory 410 stores a plurality of software modules including machine-readable instructions that, when executed by the at least one digital processor 408, cause the at least one digital processor 408 to implement functionality of AV 102 as described herein to operate autonomously within autonomous yard 104 under direction from MC 120.

When AV 102 is an electric tractor, AV 102 also includes at least one drive motor 412 controlled by a drive circuit 414 to mechanically drive a plurality of wheels (not shown) to maneuver AV 102. AV 102 also includes a location unit 416 (e.g., a GPS receiver) that determines an absolute location and orientation of AV 102, a plurality of cameras 418 for capturing images of objects around AV 102, and at least one Light Detection and Ranging (LIDAR) device 420 (hereinafter LIDAR 420) for determining a point cloud about AV 102. Location unit 416, the plurality of cameras 418, and the at least one LIDAR 420 cooperate with controller 406 to enable autonomous maneuverability and safety of AV 102. AV 102 includes a fifth wheel (FW) 422 for coupling with trailer 112 and a FW actuator 424 controlled by controller 406 to position FW 422 at a desired height. In certain embodiments, FW actuator 424 includes an electric motor coupled with a hydraulic pump that drives a hydraulic piston that moves FW 422. However, FW actuator 424 may include other devices for positioning FW 422 without departing from the scope hereof. AV 102 may also include an air actuator 438 that controls air supplied to trailer 112 and a brake actuator 439 that controls brakes of AV 102 and trailer 112 when connected thereto via air actuator 438.

Controller 406 also determines a trailer angle between AV 102 and trailer 112 based on one or both of a trailer angle measured by an optical encoder 404 positioned near FW 422 and mechanically coupled with trailer 112 and a point cloud captured by the at least one LIDAR 420.

Controller 406 may implement a function state machine that controls operation of AV 102 based upon commands (requests) received from MC 120. In the example of FIG. 3, MC 120 receives a request (e.g., via an API, and/or via a GUI used by a dispatch operator) to move trailer 112(1) from parking spot 114(1) to plurality of parking spots 114(4). Once this request is validated, MC 120 invokes a mission planner (e.g., a software package, not shown) that computes mission 128 for AV 102(2). For example, the mission plan is an ordered sequence of high level primitives to be followed by AV 102, in order to move trailer 112(1) from parking spot 114(1) to parking spot 114(4). The mission plan may include primitives such as drive along a first route, couple with trailer 112(1) in parking spot 114(1), drive along a second route, back trailer 112(1) into parking spot 114(4), and decouple from trailer 112(1).

Function state machine includes a plurality of states, each associated with at least one software routine (e.g., machine-readable instructions) that is executed by the at least one digital processor 408 to implements a particular function of AV 102. Function state machine may transitions through one or more states when following the primitives from MC 120 to complete the mission plan.

Controller 406 may also include an articulated maneuvering module, implemented as machine-readable instructions that, when executed by the at least one digital processor 408, cause the at least one digital processor 408 to controls drive circuit 414 and steering actuator 425 to maneuver AV 102 based on directives from MC 120.

Controller 406 may also include a navigation module that uses location unit 416 to determine a current location and orientation of AV 102. Navigation module may also use other sensors (e.g., camera 418 and/or LIDAR 420) to determine the current location and orientation of AV 102 using dead-reckoning techniques.

In one operational example of FIG. 3, AV 102(2) encounters a problem when performing mission 128(2) to move trailer 112(1) from parking spot 114(1) to parking spot 114(4). During a drive by of parking spot 114(4) to verify that the parking spot is clear, due to light rain and poor lighting, AV 102(2) cannot achieve sufficient confidence that parking spot 114(4) is empty prior to reversing trailer 112(1) into parking spot 114(4). Accordingly, AV 102(2) stops and requests assistance of remote support platform 302.

Remote support platform 302 determines that operator 320(1) is available and sends a request for remote assistance to operator console 322(1). Remote support platform 302 determines a bandwidth of the communication between operator console 322(1) and MC 120, and optionally between MC 120 and AV 102(2), and instructs AV 102(2) to send telemetry data 304(2) to operator console 322(1) via remote support platform 302. Since AV 102(2) has multiple cameras, and other sensors, the volume of telemetry data 304 generated by AV 102(2) (and any other AV) is large.

### Video Bakery

On AV 102, cameras 418 output encoded video streams that are stored in video buffers 419 within memory 410 for example. However, video buffers 419 and the video streams stored therein are difficult to decode and manipulate to determine a still image, which may for example be needed to resolve an issue requiring assistance. Particularly, the video feeds require complex decoding, to retrieve a still image for example. Accordingly, AV 102 is equipped with a video bakery 330 that provides a bakery interface 452 that allows other components (e.g., a telemetry application 440 and/or a remote assistance application 442) of AV 102 to retrieve still images and video streams with a variety of configuration parameters (e.g. setting frame rate, output image/video resolution, compression/encoding type). For example, remote assistance application 442 may generate a telemetry request 326 that instructs video bakery 330 to generate output stream 460 for use in telemetry data 304 being sent to operator console 322(1). Accordingly, video bakery 330 may crop and scale frames of still images and video streams to generate output stream 460.

Bakery interface 452 receives telemetry request 326 identifying an area of interest, and defining a maximum bandwidth for telemetry. For example, telemetry application 440 instructs bakery interface 452 to generate and send a telemetry feed 324 to operator console 322(1) based on a request for assistance generated by remote assistance application 442. Bakery interface 452 may invokes a feed select algorithm 458 to determine ones of the plurality of cameras 418 positioned to provide relevant information for telemetry feed 324. In one example, where remote assistance application 442 indicates assistance is required to drive AV 102 forwards, feed select algorithm 458 selects forward facing ones of the plurality of cameras 418. In another example, where remote assistance application 442 indicates assistance is required to evaluate whether parking spot 114(4) is empty, feed select algorithm 458 selects ones of the plurality of cameras 418 facing parking spot 114(4) based on the current location and orientation of AV 102 and further requests a high resolution still image of parking spot 114(4).

Bakery interface 452 determines a frame rate and/or resolution, based on the maximum bandwidth defined within telemetry request 326, for output stream 460 and/or still image 462 that are included in telemetry feed 324. Bakery interface 452 then invokes stream manipulator 456 to generate output stream 460 from one or more selected cameras 418 and invokes a still image generator 454 to process one or more image feeds from the selected cameras 418 to generate a still image 462 of the area of interest (e.g., the parking spot 114(4)). In one example of operation, telemetry request 326 identifies one or more cameras 418 of AV 102, whereby video bakery 330 generates output stream 460 and/or still image 462 based on the identified cameras and maximum bandwidth. In another example of operation, telemetry request 326 defines a point or region in three dimensional space around AV 102, whereby video bakery 330 uses feed select algorithm 458 to automatically select one or more cameras 418 based on the point or region. Feed select algorithm 458 uses camera calibration values (e.g., extrinsic and intrinsic calibration values) to project the input point/region in space into the camera frame to determine if the point/region is within a field of view of each camera on the vehicle. Bakery interface 452 then invokes a stream manipulator 456 to process image feeds from the manually or autonomously selected cameras 418 and generate an output stream 460 and/or still image 462 at the defined maximum resolution and the maximum frame rate. Accordingly, stream manipulator 456 may convert the frame rate of the image feeds from the selected cameras 418 into a frame rate less or equal to the maximum frame rate. In one example of operation, stream manipulator 456 generates output stream 460 as a composite grid of feeds, where each grid element includes at least part of a field of view of a different one of the selected cameras 418. For example, remote support platform 302 may select four cameras 418 that provide a 360 degree view around AV 102, whereby output stream 460 is divided into a two-by-two grid, and each grid element includes at least part of a field-of-view of a different one of the four selected cameras 418. For example, one or more of the grid element includes a full field of view from the corresponding camera 418. In another example of operation, to maximize usefulness of the telemetry feed 324, one or more of the grid element includes a partial field of view from the corresponding camera 418, where the partial field of view is selected based on the point/region defined within telemetry request 326. For example, where a forward-right facing camera provides a three-hundred-and-forty-degree field-of-view, stream manipulator 456 may select a ninety-degree sub-field-of-view that includes the defined point/region that corresponds to a trailer identifier that requires assistance to resolve. Accordingly, less relevant portions of the image feed from the camera are automatically excluded. Advantageously, output stream 460 provides the most relevant information without exceeding the maximum bandwidth.

Video bakery 330 sends output stream 460 and/or still image 462 to one or both of telemetry application 440 and remote assistance application 442, such that it is included in telemetry feed 324, which is sent to operator console 322(1). Video bakery 330 operates only as needed to generate output stream 460 and/or still image 462. Advantageously, video bakery 330 performs complex video decoding to get image frames from video buffers 419 and thereby facilitates use of images and video streams by other components of AV 102 and/or MC 120 without requiring knowledge of the encoding/encryption algorithms used within AV 102.

### Vehicle Credential Management (VCM)

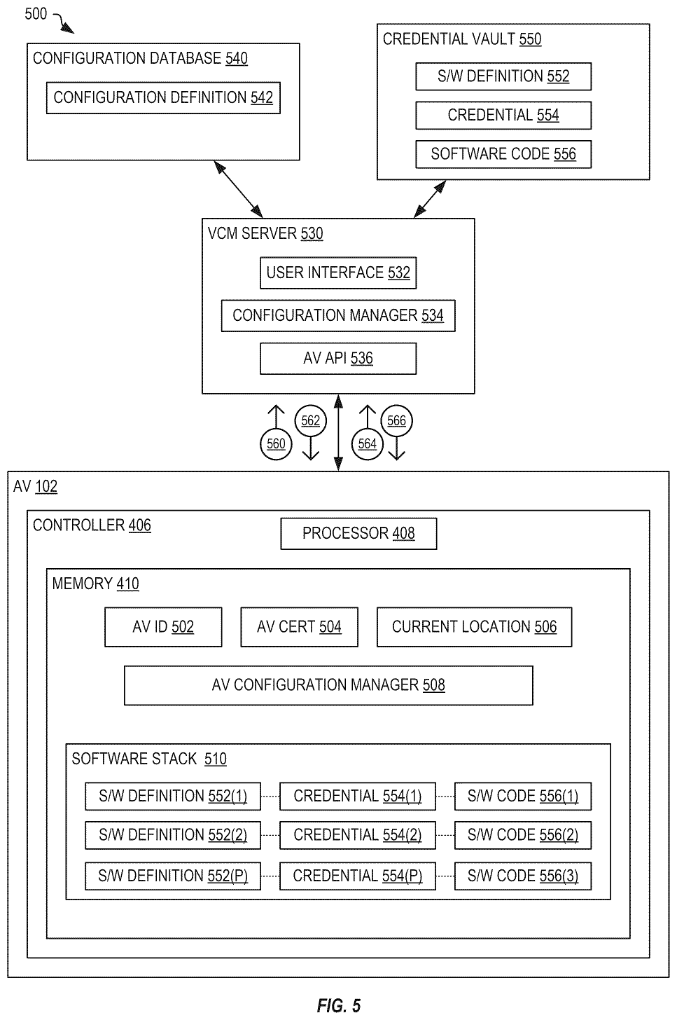

FIG. 5 shows one example VCM system 500 that facilitates autonomous configuration of AV 102, in embodiments. VCM system 500 includes a VCM server 530, a configuration database 540, and a credential vault 550. Configuration database 540 is for example implemented by a PARSE server. Credential vault 550 is for example implemented by a HashiCorp Vault. In certain embodiments, configuration database 540 and credential vault 550 are combined into a single database that may be part of VCM server 530 and/or external to VCM server 530.

AV 102 (e.g., a new AV, or new deployment of a fleet of AVs) is delivered to yard 104 with a standard, generic, software configuration, and includes a unique AV identifier 502, AV certificate 504, and an AV configuration manager 508. AV 102 also includes communication functionality that allows AV 102 to connect to a local network (e.g., a wireless LAN such as Wi-Fi). Unique AV identifier 502 is for example a hardware Universally Unique Identifier (UUID) that is unique to each AV 102 and AV certificate 504 provides authenticity to AV 102. To enable functionality of AV 102 for operation at yard 104, AV 102 requires updating with a specific software configuration (e.g., a software stack 510 that includes specific software, backend servers communication information, and/or credentials). AV configuration manager 508 is invoked during boot of controller 406 to communicate with VCM server 530 and automatically update software stack 510 if needed.

Conventionally, AV 102 configuration was performed on each AV individually based on its intended use. For example, each AV would be manually configured with a specific software load to provide capability for a specific customer at a specific yard. In another example, an operator would wirelessly connect to one AV and manually control loading of specific software and/or credentials into memory of the AV.

VCM server 530 includes a user interface 532, and configuration manager 534, and an AV API 536. AV API 536 is for example a custom GraphQL API. VCM system 500 allows cloud-based AV configuration, whereby each AV 102 updates itself autonomously under control of VCM server 530 to provide a more streamlined and scalable AV configuration solution from a centralized location. For example, each AV in a fleet of new AVs deployed to a yard is easily provisioned and/or updated with a required software stack 510 under control of VCM server 530, where configuration database 540 includes a configuration definition 542 defining software stack 510 needed to provide the intended function of AV 102.

An operator interacts with user interface 532 of VCM server 530 to create or change configuration definition 542 in configuration database 540 for an unique AV identifier 502. Configuration definition 542 is associated with at least one of a plurality of software definitions 552, corresponding credentials 554, and corresponding software code 556 that are stored within credential vault 550. In certain embodiments, software code 556 is stored elsewhere and manually downloaded into each AV 102 as needed.

Configuration definition 542 defines ones of software definition 552, credentials 554, and corresponding software code 556 that are downloaded to AV 102 to form software stack 510. Software definition 552 identifies software code 556 (e.g., software including machine readable instructions) and/or configuration data (e.g., operational parameters and definitions for one or more software modules) that may be loaded into software stack 510 of AV 102 to provide a specific functionality of AV 102. Accordingly, an operator updates one or more of configuration definition 542, credentials 554, and/or software code 556 to update functionality of one or more AVs 102. Advantageously, at next initialization of each AV 102 (e.g., at next boot), AV configuration manager 508 communicates with VCM server 530 via AV API 536 to autonomously receive software definition 552, corresponding credentials 554, and/or software code 556 associated with configuration definition 542, where configuration definition 542 matches unique AV identifier 502 of AV 102. In certain embodiments, AV configuration manager 508 may also be triggered to update software stack 510 by receiving a command sent from VCM system 500.

Configuration manager 534 may implement a dashboard, displayed by user interface 532, that allows the operator to interactively create and/or update configuration definition 542 as needed. In certain embodiments, configuration manager 534 includes intelligence that facilitates the creation and/or update of configuration definition 542 based on software definitions 552 and credentials 554 stored within credential vault 550, thereby ensuring software stack 510 is configured correctly and up to date. Software developers may add software definition 552 to credential vault 550, and credentials 554 may be updated as needed (e.g., new credentials generated as existing credentials expire). Accordingly, to deploy new software code 556, an operator updates configuration definition 542, whereby AV 102 then autonomously updates its software stack 510 by interacting with VCM server 530 via AV API 536.

In certain embodiments, user interface 532 and configuration manager 534 cooperate to implement a full featured UI that allows an operator to manage fleets of AVs. For example, user interface 532 may display an overview of AVs 102 that are running each version of software and where they are deployed, where AVs 102 may be assigned to groups for easier management, such as allowing the operator to make configuration changes to all AVs in the group based on certain criteria (e.g., hardware, site, etc.). User interface 532 may allow the operator to rotate keys and certificates across one or more AVs, and allow the operator to compare software versions and configurations on different AVs. User interface 532 may also allow the operator to update credentials, configuration, and corresponding/compatible software collectively. For example, where a software program/package is updated (e.g., to a new version), user interface 532 allows the operator to update relevant AVs (e.g., AVs that include the old version of the software) with updated configuration definitions 542 that cause each AV 102 to automatically interact with VCM server 530 to retrieve the associated software definition 552, credentials 554, and updated software code 556.

Credential vault 550 securely stores many software definitions 552 and many credentials 554, and each configuration definition 542 within configuration database 540 defines which of these software definition 552 and credentials 554 are to be loaded in the corresponding AV 102. Configuration definition 542 may also define which backend servers the AV should communicate with, and so forth.

In certain embodiments, configuration definition 542 defines basic version information associated with each AV. For example, configuration definition 542 defines the required capabilities of AV 102 to function within yard 104. In certain embodiments, configuration manager 534 processes configuration definition 542 to determine needed software code 556 and credentials required by AV 102, and then updates configuration definition 542 to reference one or more credentials 554 and/or software definition 552 stored in credential vault 550. Accordingly, configuration definition 542 defines needed software definition 552 and credentials 554 of AV 102.

In certain embodiments, AV configuration manager 508 is invoked at each boot of controller 406 and sends a registration request 560 to configuration manager 534 via AV API 536. Registration request 560 includes unique AV identifier 502, AV certificate 504, and a current location 506 of AV 102. For example, AV configuration manager 508 determines current location 506 of AV 102 using location unit 416. Configuration manager 534 authenticates registration request 560, and thus AV 102, based on registration request 560. For example, configuration database 540 may defines a list of valid unique AV identifiers 502 in association with a geographic area of yard 104. For AV 102 to be authenticated, configuration manager 534 verifies that unique AV identifier 502 is listed within configuration database 540, and verifies one or more of current location 506 is within the defines geographic areas of yard 104, and that AV certificate 504 is authentic and current. In certain embodiments, configuration manager 534 verifies that registration request 560 was received via an allowed network (e.g., the wireless LAN at yard 104).

In one example of operation, at startup of AV 102, AV configuration manager 508 sends registration request 560 including at least unique AV identifier 502 to configuration manager 534 via AV API 536. Once registration request 560 and AV 102 are authenticated, configuration manager 534 retrieves configuration definition 542 from configuration database 540 based on unique AV identifier 502, and sends configuration definition 542 to AV configuration manager 508 in a configuration status message 562.

AV configuration manager 508 compares configuration definition 542 to software stack 510 to determine whether any updates to software stack 510 are needed. Where software updates are needed, AV configuration manager 508 sends an update request 564 to configuration manager 534 via AV API 536, where update request 564 identifies ones of software definition 552 and/or credentials 554 required by AV 102. In response, configuration manager 534 sends requested ones of software definitions 552 and/or credentials 554 to AV configuration manager 508 via AV API 536 as a configuration message 566. AV configuration manager 508 updates software stack 510 with the received software definitions 552 and/or credentials 554. Accordingly, software stack 510 is autonomously updated by AV 102 with needed software definition 552 and credentials 554 for operation at yard 104.

Since credentials may be loaded during booting of controller 406, it is unnecessary to embed the credentials within software modules. In certain embodiments, credentials 554 are stored in volatile memory of controller 406 and are lost when controller 406 powers down. In another embodiment, AV configuration manager 508 deletes credentials 554 from software stack 510 when AV 102 shuts down. Advantageously, where credentials 554 are not stored in non-volatile memory (or are specifically deleted), the security risk of credentials being copied is reduced. A further advantage of this solution is that credentials 554 are easily updated since credentials 554 are loaded from VCM server 530 at each boot, thereby allowing credentials to be rotated as needed.

In certain embodiments, as part of increased security, configuration manager 534 only allows registration to occur when last registered date (e.g., stored in configuration database 540 in association with unique AV identifier 502) is null or indicates that a previous registration was within a predefined amount of time (e.g., 1 week). In these embodiments, when AV 102 is authenticated, configuration manager 534 stores a timestamp (e.g., current date and time) in configuration database 540 in association with unique AV identifier 502 to indicate when a last registration of AV 102 occurred.

In certain embodiments, configuration manager 534 notifies an operator of the registration, whereby the operator authorizes provisioning of AV 102. If re-registration is required in edge cases (e.g., when AV certificate 504 has not automatically updated because AV 102 was offline for an extended period of time), an operator may interact with user interface 532 and configuration manager 534 to manually add a temporary exception to configuration definition 542 to allows registration and/or provisioning of AV 102 having the corresponding unique AV identifier 502. Alternatively, to facilitate an initial registration of AV 102, AV certificate 504 is manually installed onto AV 102, where AV certificate 504 allows AV 102 to register with configuration manager 534.

Advantageously, update of the software stack on AV 102 is simplified to changing configuration definition 542, whereby software stack 510 is updated during a need boot of controller 406 of AV 102. In certain embodiments, when configuration definition 542 is modified, configuration manager 534 sends a message to AV 102 to cause controller 406 to invoke AV configuration manager 508 to re-register and thereby update software stack 510.

Configuration definitions 542 may have a hierarchical definitions where portions of configuration definition 542 that are common to multiple AVs 102 are shared. Advantageously, a fleet of AVs 102 at yard 104 are easily configured and/or updated in a more streamline way from VCM system 500.

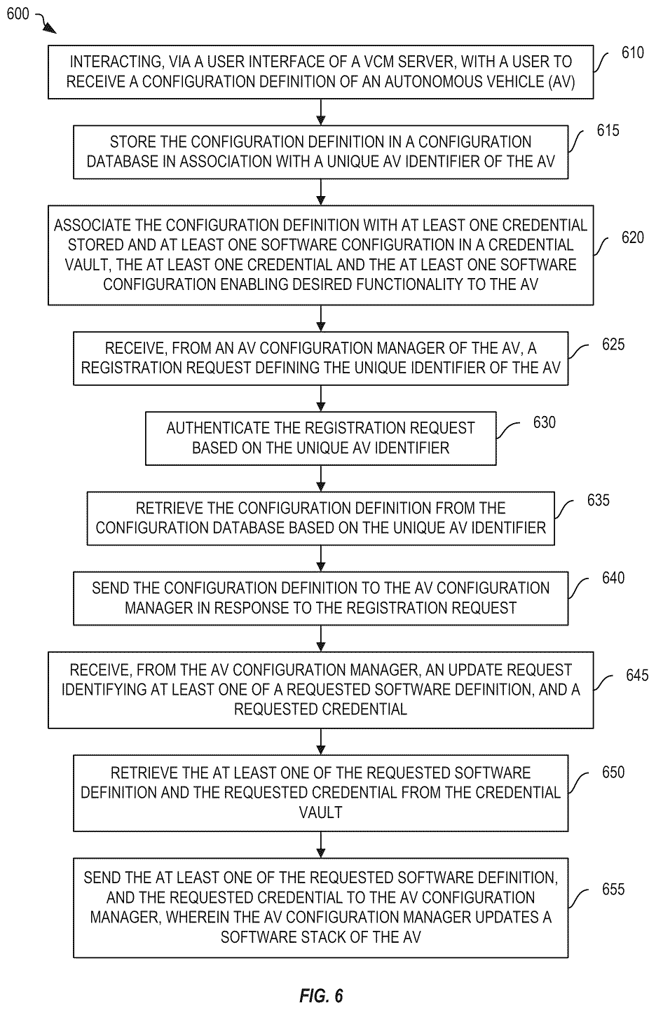

FIG. 6 is a flowchart illustrating one example VCM method 600, in embodiments. VCM method 600 is for example implemented with configuration manager 534 of VCM server 530 and shows one example registration and provisioning of AV 102 by configuration manager 534.

In block 610, VCM method 600 interacts, via a user interface of a VCM server, with a user to receive a configuration definition of an AV. In one example of block 610, configuration manager 534 interacts with an operator via user interface 532 to receive configuration definition 542.

In block 615, VCM method 600 stores the configuration definition in a configuration database in association with a unique AV identifier of the AV. In one example of block 615, configuration manager 534 stores configuration definition 542 in configuration database 540.

In block 620, VCM method 600 associates the configuration definition with at least one credential stored and at least one software configuration in a credential vault, the at least one credential and the at least one software configuration enabling desired functionality to the AV. In one example of block 620, configuration manager 534 associates configuration definition 542 with one or more software definitions 552 and/or credentials 554 of credential vault 550.

In block 625, VCM method 600 receives a registration request defining the unique identifier of the AV from an AV configuration manager of the AV. In one example of block 625, configuration manager 534 receives registration request 560 from AV configuration manager 508 of AV 102. In block 630, VCM method 600 authenticates the registration request based on the unique AV identifier. In one example of block 630, configuration manager 534 authenticates registration request 560 by verifying one or more of: the included unique AV identifier 502 is listed in configuration database 540, the included AV certificate 504 is valid, the included current location 506 is within a defined operational area for yard 104, and/or registration request 560 was received from an expected network (e.g., a network configured at yard 104).

In block 635, VCM method 600 retrieves the configuration definition from the configuration database based on the unique AV identifier. In one example of block 635, configuration manager 534 retrieves configuration definition 542 from configuration database 540 based on unique AV identifier 502 received in registration request 560.

In block 640, VCM method 600 sends the configuration definition to the AV configuration manager in response to the registration request. In one example of block 640, configuration manager 534 sends configuration status message 562 including configuration definition 542 to AV configuration manager 508 of AV 102.

In block 645, VCM method 600 receives, from the AV configuration manager, an update request identifying at least one of a requested software definition, and a requested credential. In one example of block 645, configuration manager 534 received update request 564 from AV configuration manager 508 via AV API 536.

In block 650, VCM method 600 retrieves the at least one of the requested software definition, and the requested credential from the credential vault. In one example of block 650, configuration manager 534 retrieves ones of software definition 552 and credentials 554 identified within update request 564.

In block 655, VCM method 600 sends the at least one of the requested software definition, and the requested credential to the AV configuration manager, wherein the AV configuration manager updates a software stack of the AV. In one example of block 655, configuration manager 534 sends configuration message 566 including identified ones of software definition 552 and/or credentials 554 to AV configuration manager 508 of AV 102.

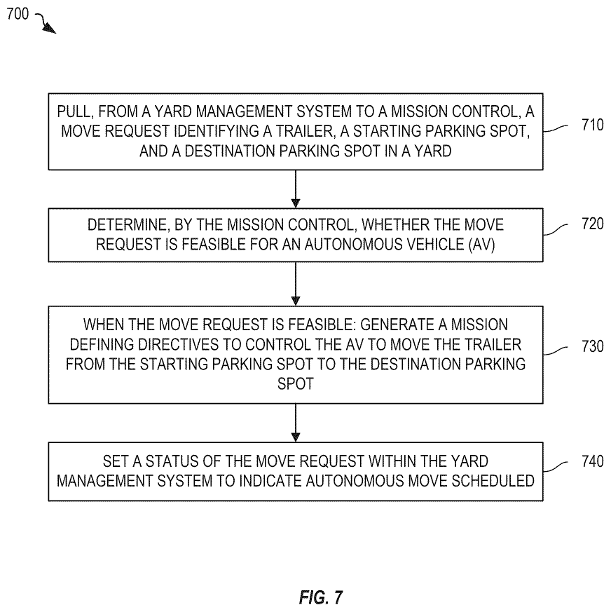

FIG. 7 is a flowchart illustrating one example remote based control method 700 for autonomous operation, in embodiments. Method 700 is for example implemented in one or more of puller 122, assessor 124, scheduler 125, and updater 127 of MC 120 of FIG. 1.

In block 710, method 700 pulls, from a yard management system to a mission control, a move request identifying a trailer, a starting parking spot, and a destination spot in a yard. In one example of block 710, puller 122 pulls move request 108(3) from move queue 110 of YMS 106.

In block 720, method 700 determines, at the mission control, whether the move request is feasible for an AV. In one example of block 720, assessor 124 determines that move request 108(3) meets criteria for an autonomous move by AV 102. In another example of block 720, assessor 124 determines that the move is not feasible by the AV when trailer 112(1) is not parked within parking spot 114(1), which is the starting parking spot.

In block 730, method 700, when the move request is feasible, generates a mission defining directives to control the AV to move the trailer from the starting parking spot to the destination spot. In one example of block 730, scheduler 125 generates mission 128 with directives to control AV 102(1) to hitch with trailer 112(1) in parking spot 114(1), drive trailer 112(1) to, and reverse trailer 112(1) into, parking spot 114(4), and to unhitch from trailer 112(1).

In block 740, method 700 sets, via an API of the YMS, a status of the move request to indicate autonomous move scheduled. In one example of block 740, updater 127 sets, via API 107, status 109(3) to indicate autonomous move scheduled.

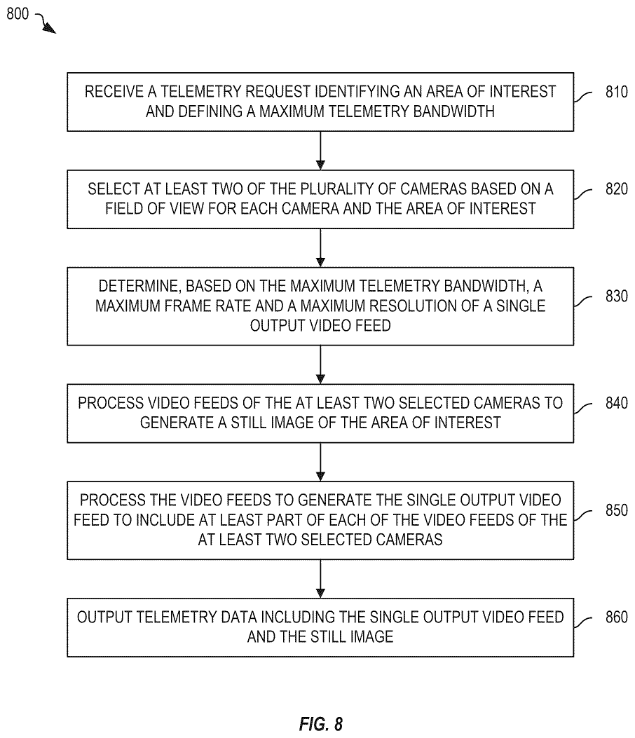

FIG. 8 is a flowchart illustrating one example video bakery method 800 for an autonomous vehicle having a plurality of cameras, in embodiments. Video bakery method 800 is for example implemented by video bakery 330 within controller 406 of AV 102.

In block 810, method 800 receives a telemetry request identifying an area of interest and defining a maximum telemetry bandwidth. In one example of block 810, bakery interface 452 receives telemetry request 326 from remote assistance application 442.

In block 820, method 800 selects at least two of the plurality of cameras based on a field of view for each camera and the area of interest. In one example of block 820,

In block 830, method 800 determines, based on the maximum telemetry bandwidth, a maximum frame rate and a maximum resolution of a single output video feed. In one example of block 830,

In block 840, method 800 processes video feeds of the at least two selected cameras to generate a still image of the area of interest. In one example of block 840,

In block 850, method 800 [processes the video feeds to generate the single output video feed to include at least part of each of the video feeds of the at least two selected cameras. In one example of block 850,

In block 860, method 800 outputs telemetry data including the single output video feed and the still image. In one example of block 860,

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A remote based control method for autonomous operation, comprising:
receiving, at a mission control from a yard management system (YMS), a move request defining a destination spot in a yard and one or more of a trailer identifier of a trailer to be moved, a pick-up spot of the trailer, and a trailer type;
determining, at the mission control, whether the move request is feasible for an autonomous vehicle (AV); and
when the move request is feasible:
generating a mission defining directives to control the AV to move the trailer from the pick-up spot to the destination spot; and
setting, via an application programming interface (API) of the YMS, a status of the move request to indicate autonomous move scheduled.

2. The remote based control method of claim 1, the determining comprising:
determining, based on weather data received at mission control, when operation of the AV is not possible;
updating an operational schema of the AV to indicate that operation of the AV is not possible; and
sending the operational schema to the YMS.

3. The remote based control method of claim 1, the determining further comprising determining that the move request is not feasible when gladhand data indicates that the AV cannot move the trailer.

4. The remote based control method of claim 1, the determining further comprising determining that the move request is not feasible when trailer information indicates that the trailer is damaged.

5. The remote based control method of claim 1, setting the status of the move request within the YMS to indicate autonomous move not feasible when the move request is not feasible.

6. The remote based control method of claim 1, when the move request defines the destination spot and one or both of the trailer identifier and the pick-up spot of the trailer, the determining comprising determining that (a) the trailer is parked in the pick-up spot, (b) the destination spot is empty, (c) at least one AV is available and capable of moving the trailer from the pick-up spot to the destination spot, and (d) the move meets certain criteria.

7. The remote based control method of claim 6, the criteria comprising at least one of: the trailer being undamaged, there is no inventory issue for the trailer, and there are no issues at a loading dock when at least one of the pick-up spot and the destination spot is a loading dock.

8. The remote based control method of claim 7, the issues at the loading dock including a dock light of the loading dock not being green.

9. The remote based control method of claim 1, when the move request only defines the trailer identifier and the destination spot, the determining comprising searching an inventory of the YMS to determine the pick-up spot.

10. The remote based control method of claim 1, when the move request only defines the trailer type and the destination spot, the determining comprising (a) searching a trailer database of the YMS to determine the trailer identifier of a trailer that matches the trailer type, and (b) searching an inventory of the YMS to determine the pick-up spot for the trailer having the trailer identifier.

11. The remote based control method of claim 1, further comprising:
receiving, at the mission control, a mission status indicative of success from the AV when the mission is completed by the AV; and
updating the YMS to indicate that the move request is done.

12. The remote based control method of claim 11, further comprising updating inventory information of the YMS to indicate that the pick-up spot is empty and that the destination spot contains the trailer having the trailer identifier.

13. The remote based control method of claim 1, further comprising:
receiving a mission status from the AV indicating that the AV is unable to complete the mission; and
updating the YMS to indicate that the move request is not done.

14. The remote based control method of claim 1, further comprising:
sending the mission to the AV;
receiving a mission status indicative of the destination spot not being empty from the AV;
searching an inventory of the YMS for an empty nearby spot; and
updating the mission to define directives to control the AV to deposit the trailer in the empty nearby spot.

15. The remote based control method of claim 1, further comprising:
sending the mission to the AV;
receiving a mission status indicative of the destination spot not being empty from the AV;
determining, from an inventory of the YMS, that no nearby spot is empty;
sending an instruction to the AV to search for empty nearby spots;
receiving a message identifying an empty nearby spot from the AV; and
updating the mission to define directives to control the AV to deposit the trailer in the empty nearby spot.

16. The remote based control method of claim 1, further comprising:
sending the mission to the AV;
receiving a mission status indicating that the trailer with the trailer identifier is not at the pick-up spot from the AV;
determining, from an inventory of the YMS, a new pick-up spot; and
updating the mission to define directives to control the AV to collect the trailer from the new pick-up spot.

17. The remote based control method of claim 1, further comprising:
sending the mission to the AV;
receiving a mission status indicating that the trailer with the trailer identifier is not at the pick-up spot from the AV;
determining, from an inventory of the YMS, no new pick-up spot is found;
sending an instruction to the AV to identify nearby trailers;
receiving a message with a found trailer identifier from the AV;
determining that the found trailer identifier matches the trailer identifier; and
updating the mission to define directives to control the AV to collect the trailer from the new pick-up spot and move it to the destination spot.
